(19) United States
(12) Patent Application Publication
(10) Pub. No.: US 2018/0222003 A1
(43) Pub. Date: Aug. 9, 2018

(54) MACHINING UNIT WITH A MOVABLE CARRIAGE

(71) Applicant: Watch Out SA, Geneve (CH)

(72) Inventors: Philippe Jacot, Bevaix (CH); Sebastien Laporte, Thyez (FR)

(73) Assignee: Watch Out SA, Geneve (CH)

(21) Appl. No.: 15/580,794

(22) PCT Filed: Jun. 9, 2016
(86) PCT No.: PCT/IB2016/053386

§ 371 Date: Dec. 8, 2017

(30) Foreign Application Priority Data
Jun. 11, 2015 (CH) 00834/15

(51) Int. Cl. B23Q 11/08; B23Q 3/18

(52) U.S. Cl. CPC B23Q 11/0891; B23Q 3/18

(57) ABSTRACT

A machining unit including at least one machining module. The machining module includes a protective compartment that delimits an enclosure and has a front door, which can go from a closed position to an open position defining an opening. A machining assembly is provided with a tool-holder and a part-holder. A movable carriage receives the machining assembly and can slide on a guide device, between a first position in which the machining assembly is accommodated in the enclosure and a second position in which the carriage projects from the protective compartment via the opening and the machining assembly is situated outside the enclosure. In the first position, the front door can be closed for the purpose of carrying out machining of a part by the machining assembly. The second position permits access to the machining assembly from the exterior of the protective compartment.

### TECHNICAL FIELD

The present invention relates to the field of machine tools, and in particular concerns a machining unit.

The machine tool has objectives of improvement relating to precision, the quality of the parts (state of surface, state of form, burr, etc.), for the purpose of increasing productivity and flexibility and reducing space required on the ground.

As the main example, reference can be made to mechanical horology, in which there is continual striving to improve the precision and quality of production of the components, in order to improve the performance of the movements, and the assembly output in production. Other examples are the motor vehicle, medical, spatial or electronics industries.

The machines for machining horology components are production machines which are designed to work continuously 24 hours a day, with a minimum of human intervention. As an example, reference can be made to automatic lathes which are used to produce most of the revolution components of a movement, or transfer machines for parts of the disc and bridge type, etc.

These machines tools take up a large amount of space on the ground in view of their size alone, and account must also be taken of the space necessary for accessibility to all the parts of the machine tool by the operator. This situation gives rise to increasingly great requirements for space, taking into account the significant number of machines of this type which are present in a workshop of a conventional size. Consequently, it is also necessary to face up to logistics which are made more complex: this involves in particular the supply of bars, maintenance, and regulation, either to set-up each machine (programming for the production of a new part) or for starting up (operations such as replacement of one of the tools, for continuation of production of a single series of parts).

In addition, the interventions by the operator on these machine tools are often made uncomfortable, in particular by limited access to certain parts of the machine tool, and according to a configuration which is not ergonomic, in an environment where oil is omnipresent. Improvement of the ergonomics of the machine tools, and in particular accessibility to the tool-holder and part-holder is therefore desirable.

### PRIOR ART

Document US2011305537A describes a machine tool which permits improved access to, and replacement of, its tools. For this purpose, the machine tool is provided with lateral walls, a front wall, a rear wall and an upper cover with a vertical work position, and which can be pivoted downwards for facilitated access to the machine. The part is placed on a part-holder support which slides in a first horizontal direction X, and the tool-holder is movable in a vertical direction Z, and in a second, horizontal direction Y. In this case, it is understood that it is necessary to have a large space all around the machine tool in order to permit opening of the walls and the cover, and thus access the tool and/or the part.

Document US2007042882 describes a machine tool, access to which is possible by means of a front door, a rear door, and an upper wall which can be deployed and folded back in the manner of an accordion. A carriage which is movable on rails in a first horizontal direction Y receives the tool-holder, which allows the latter to approach or move away from the part-holder (see FIGS. 3 to 6).

JP2012223876A describes a machine tool in a support which receives the part-holder and its headstock, and is movable in translation on a carriage, thus allowing the part-holder to exit partly from the machining enclosure.

JP2003071663A describes a miniaturized machine tool delimited in a machining chamber. The part-holder is fitted on a door which is movable on the plane X-Y.

The machine tools according to the prior art thus propose machine tools with protective compartments with a plurality of doors or walls which are retractable for improved access by the operator to the part-holder and/or to the tool-holder. However, there is still a significant need for a machine tool wherein not only access to the part-holder and the tool-holder is made easy, but which also takes up a reduced space on the ground.

### BRIEF SUMMARY OF THE INVENTION

An objective of the present invention is to propose a machining unit which is without the limitations of the known machining machines.

Another objective of the invention is to propose a machining unit which has improved ergonomics, so that the operator can easily access both the tool-holder and the part-holder outside production periods.

Another objective of the invention is to propose a machining unit which permits access to all the machining components via the same opening.

According to the invention, these objectives are achieved in particular by means of a machining unit comprising at least one machining module, said machining module comprising a protective compartment which delimits an enclosure and has a front door, which can go from a closed position to an open position defining an opening, a machining assembly provided with a tool-holder and a part-holder, a movable carriage which receives said machining assembly and can slide on a guide device, between a first position in which said machining assembly is accommodated in said enclosure, and the front door can be closed for the purpose of carrying out machining of a part by said machining assembly, and a second position in which the carriage projects from the protective compartment via said opening, and said machining assembly is situated outside said enclosure, which permits access to the machining assembly from the exterior of the protective compartment.

Thus, in the first position of the movable carriage, constituting a work position, the machining assembly is accommodated in the closed enclosure, and permits the production of series of parts according to the conventional machining techniques.

In the second position of the movable carriage, constituting a position without production or processing position, the machining assembly is placed outside the enclosure, with the carriage extending out of the enclosure through the opening formed after the front door has been opened.

This solution has the advantage in particular, in comparison with the prior art, of making it possible to extract all the parts of the machining assembly from the protective compartment, i.e. the tool-holder and the associated part-holder, in a single operation of extracting the carriage from the protective compartment. By this means, in the processing position, the operator can carry out all the handling operations necessary on the tool-holder and/or the part-holder, in particular for maintenance, regulation, a change of program, replacement of the machining assembly or of certain parts of the machining assembly.

The assembly formed by the tool-holder and the part-holder delimits a machining area. In the second position of the movable carriage, this machining area is accessible from three sides out of four and from above the carriage, and on the exterior of the protective compartment, in particular at the front of the protective compartment.

Preferably, in the second position of the movable carriage, the vertical projection of the machining assembly is situated on the exterior of the support polygon of the protective compartment. Preferably, in the second position of the movable carriage, the vertical projection of the machining assembly is situated on the exterior of the vertical projection of the protective compartment. By this means, the operator can access all of the machining area without his hands penetrating in the protective compartment, and without having to perform any contortion, the operator being able to remain upright and close to the carriage with his legs straight and his feet below the carriage.

In addition, in comparison with the prior art, it is possible to use a protective compartment with a single door for the machining module, i.e. the front door, which simplifies the design and production of the protective compartment. This very compact design makes it possible to use freely the space situated on both sides and at the rear of the protective compartment, including in the processing position. It is thus possible to associate a plurality of machining modules oriented in the same direction with the front door placed at the front of the machining unit comprising said machining modules.

Thus, the invention also relates to a machining unit comprising a plurality of machining modules placed side-by-side adjoined to one another. The saving in space is very considerable, as will be described in greater detail hereinafter.

### BRIEF DESCRIPTION OF THE FIGURES

Embodiments of the invention are indicated in the description illustrated by the appended figures in which:

FIG. 1 illustrates a machining unit according to a first embodiment, seen from the side and in cross-section in the direction I in FIG. 2, in the first position of the movable carriage;

FIG. 2 represents the machining unit according to the first embodiment, seen from the front face in the direction II in FIG. 1, without the glass of the front door;

FIG. 3 represents the machining unit according to the first embodiment, in perspective, from the front face and the lateral side;

FIGS. 4 and 5 are views similar to those of FIG. 3, with the movable carriage in its second position;

FIG. 6 represents a machining unit according to a variant embodiment, in perspective, from the front face and the lateral side, comprising five machining modules and all the carriages in the first position;

FIG. 7 is a view similar to that of FIG. 6, with the carriage of one of the machining modules in the second position, the corresponding machining assembly being extracted from the protective compartment;

FIG. 8 represents a machining unit according to a second embodiment, in perspective, from the front face and the lateral side, comprising five machining modules and all the carriages in the first position; and

FIG. 9 is a view similar to that of FIG. 8, with the carriage of one of the machining modules in the second position, the corresponding machining assembly being extracted from the protective compartment.

### DETAILED DESCRIPTION

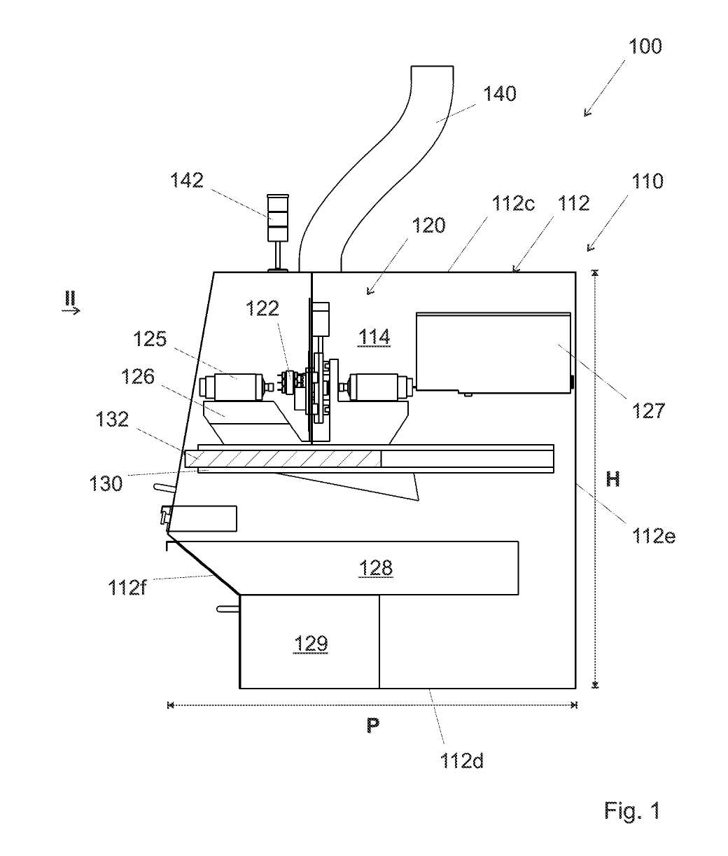

Reference is made to FIGS. 1 to 3, representing a machining unit 100 according to a first embodiment, comprising a single machining module 110 represented without the front door, in order to show better the interior of the machining module 110.

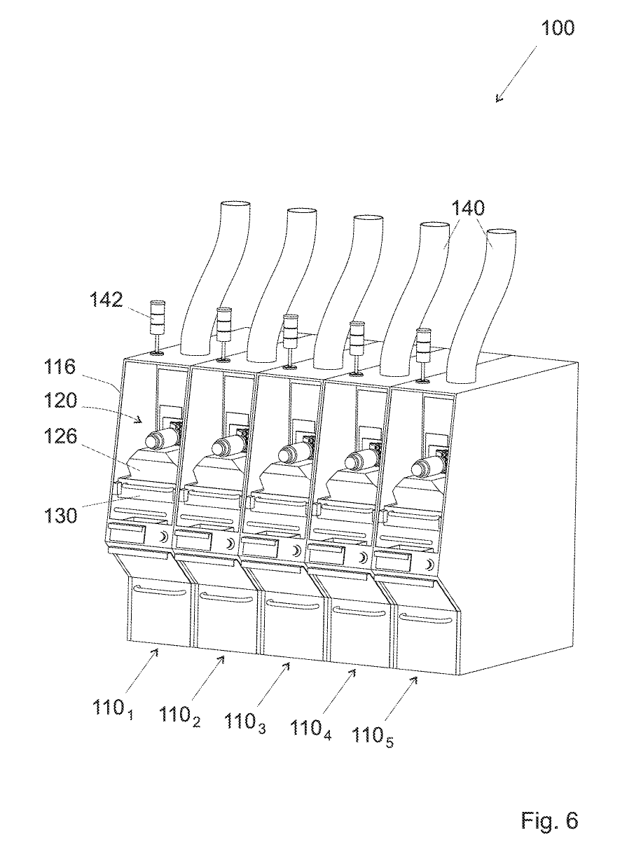

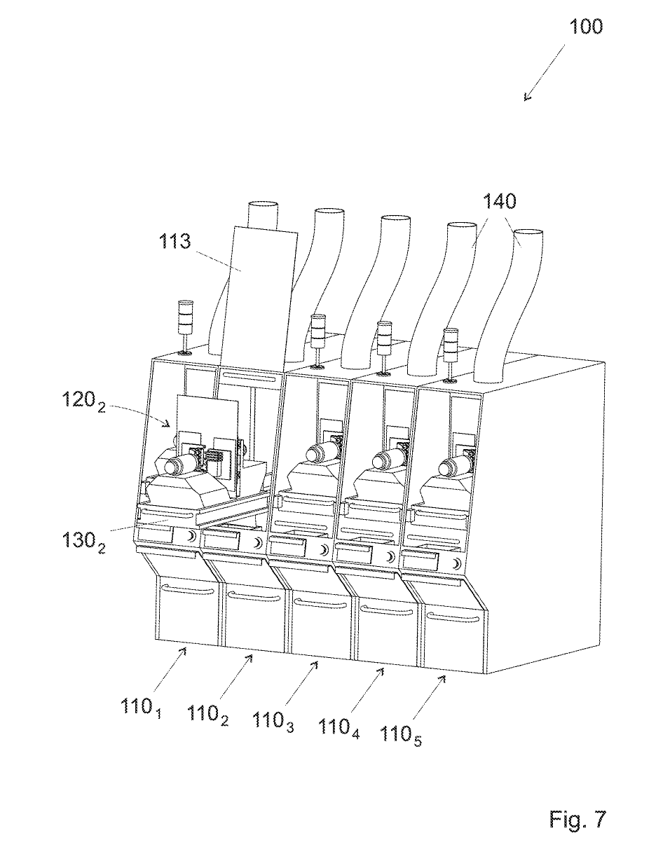

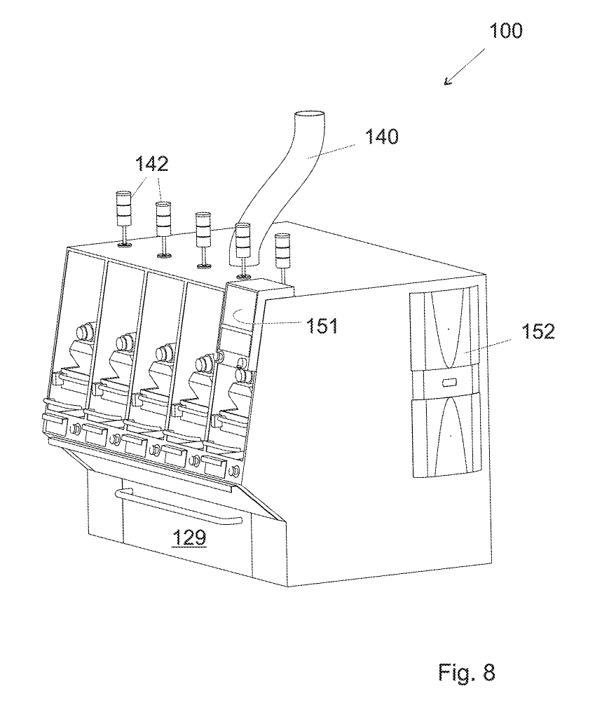

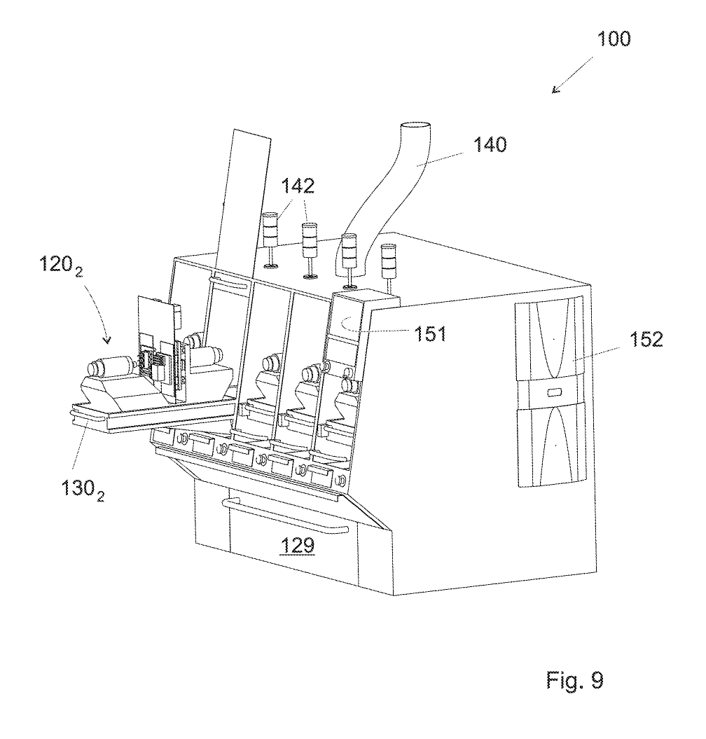

This machining module 110 forms a compact unit, substantially in the form of a rectangular parallelepiped with a height H (largest dimension in the vertical direction) and a depth P (largest dimension in the horizontal direction), at least twice, or even at least three times larger than the width L (smallest dimension in the horizontal direction). This narrow, slender form takes up a small amount of space on the ground and makes it possible to associate a plurality of machining modules 110 within a single machining unit 100, as will be described hereinafter with reference to FIGS. 6 and 7, illustrating a variant of the embodiment, and in relation with FIGS. 8 and 9, illustrating a second embodiment. It will be appreciated that different forms of this narrow shape are possible for the machining module 110, without departing from the scope of the present disclosure.

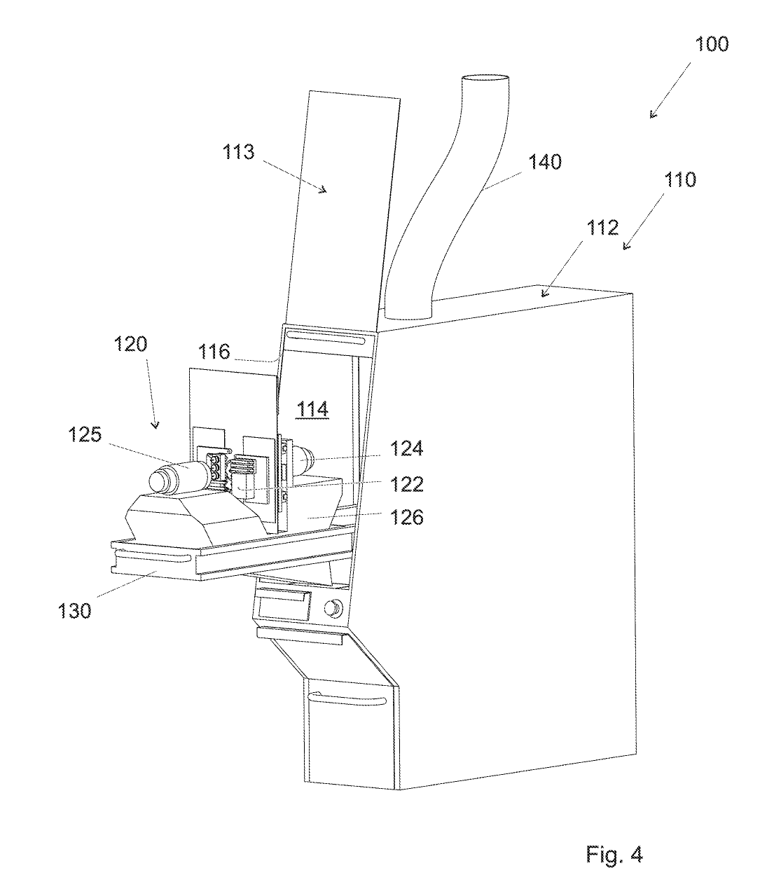

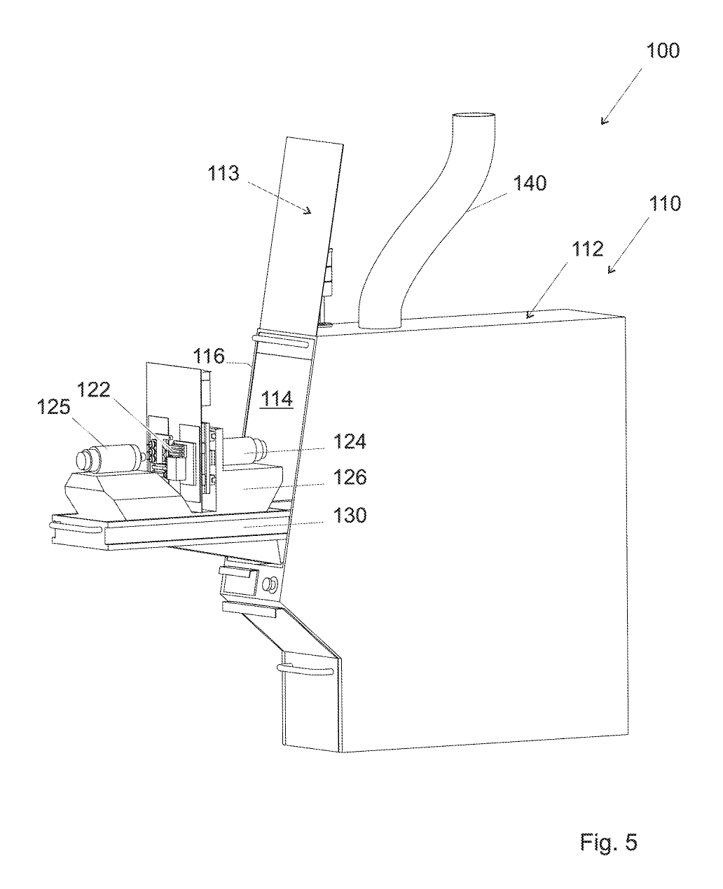

The machining module 110 is delimited by a protective compartment 112, constituting a closed envelope delimiting an enclosure 114 which can be rendered sealed. This protective compartment 112 comprises two vertical lateral walls 112a and 112b parallel to one another, a horizontal upper wall 112c parallel to a lower wall 112d, a vertical rear wall 112e, and a front wall 112f (in this case with a plurality of panels) comprising a front door 113 (not represented in FIGS. 1 to 3 but shown in FIGS. 4 and 5). This front door 113 is shown in a configuration of opening from the top, in particular according to a movement of sliding, in FIGS. 4 and 5, which represent it in the open state.

In FIGS. 1 to 3, the opening 116 delimited in the front wall 112f makes it possible to see the enclosure 114, containing in particular a machining assembly 120. This machining assembly 120 comprises at least one tool-holder 122 and one part-holder 124. In FIGS. 1 to 5, the part-holder 124 is a spindle, and the machining assembly also comprises a counter-spindle 125 (second part-holder).

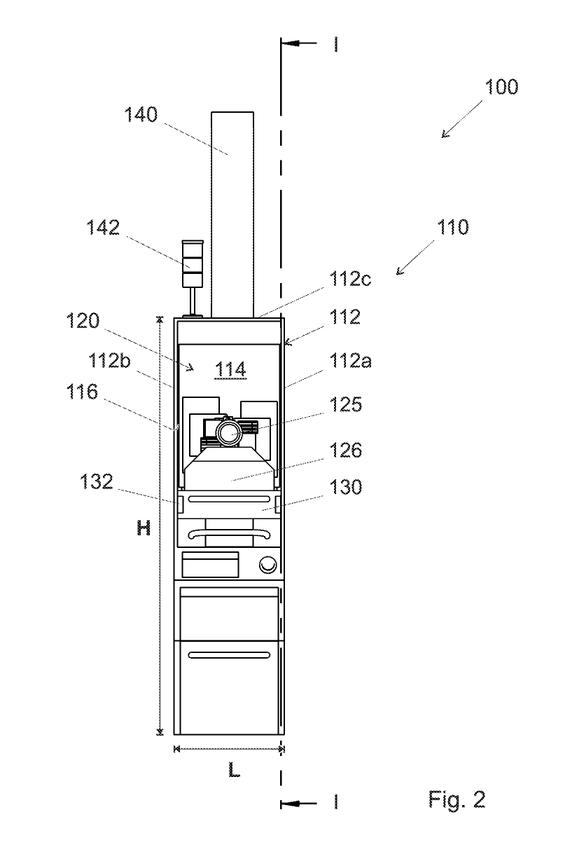

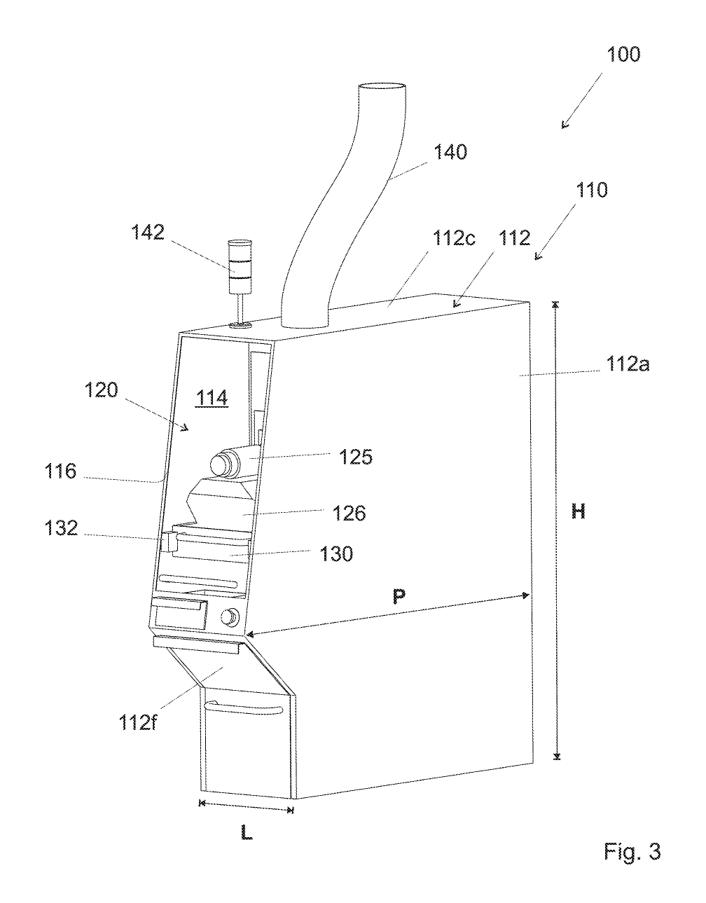

The machining assembly 120 is fitted on a movable carriage 130. In the figures, this movable carriage 130 is in the form of a slide. Preferably, the carriage 130 forms a receptacle which can recuperate all lubrication liquid, in particular oil, and the swarf of material derived from machining of a part by the machining assembly. In order to permit the movement of advance out of the opening 116 and the movement of withdrawal into the enclosure of this movable carriage 130, the latter is fitted on the guide device 132. In particular, this guide device 132 can be in the form of rails, as can be seen in FIGS. 2 and 3. In FIGS. 2 and 3, the rails 132 are fitted directly on the lateral walls 112b of the protective compartment 112 which acts as a bearing structure for the machining module 110. According to other variants, not represented, this guide device and/or the movable carriage 130 comprise rollers or other rolling elements, or sliding runners, or any other sliding element.

According to another variant embodiment, not represented, the protective compartment 112 acts as an envelope and surrounds the frame of the machining module 110, with this frame supporting the guide device and supporting the guide carriage, and thus the machining assembly 120.

In the second position of the movable carriage 130, access to the machining assembly 120 is possible from at least four sides, i.e. from above and from three of the four lateral sides (front side, right side and left side) of the machining assembly 120/of the carriage 130 (FIGS. 4 and 5).

In addition, in FIGS. 1 to 5, the machining assembly 120 is placed on a support base 126 on which the spindle 124 and the counter-spindle 125 are fitted, as well as the tool-holder or a plurality of tool-holders 122. The support base 126 is received directly on the movable carriage 130. Thus, it will be understood that it is possible to change a complete machining assembly 120 of a machining module, simply by separating the support base 126 from the movable carriage 130, and placing on it a new support base 126 equipped with another machining assembly 120. In addition, by this means, there are retained together on the support base 126 a tool-holder 122 and a part-holder 124 which are matched, and wherein, during prior calibration, it is possible to determine the relative position between the tool-holder 122 and the part-holder 124, then to retain this relative position for as long as the tool-holder 122 and the part-holder 124 continue to be fitted on the support base 126, without further regulation.

According to a variant embodiment not represented, the front door 113 of the protective compartment can be pivoted between its open position and its closed position. Also, according to a variant embodiment not represented, the front door 113 of the protective compartment opens downwards. In this case, according to an alternative embodiment, the front door 113 acts as a support for the movable carriage 130, and comprises at least part of the guide device 132. In this case, it is possible to provide an arrangement wherein the sliding movement of said carriage 130 is carried out simultaneously with the opening or closure of the front door 113. In another alternative, the arrangement is such that the opening of the front door 113 must be effective in order to permit the sliding movement of said carriage 130.

The machining module 110 also comprises an electrical control box, not represented in FIGS. 1 to 7, situated for example on the rear wall 112e. This electrical control box is placed in the enclosure 114, or on the exterior of the enclosure 114. The enclosure 114 also comprises a swarf container 128 below the movable carriage 130, and an oil container 129, below the swarf container 128. In order to recuperate the oil and the swarf in the dedicated containers 128 and 129, the base of the carriage 130 is provided with holes, and is for example equipped with a grid or a guide which is above the swarf container in the first position of the movable carriage 130 (FIGS. 1 to 3).

In addition, the machining module 110 is equipped with a compartment for collection of the lubrication liquid (oil container 129) and a circuit for recycling said lubrication liquid. Preferably, said

circuit for recycling said lubrication liquid is thermostatted in order to control the temperature of the lubrication liquid.

According to another optional arrangement, said enclosure 114 is thermostatted in order to control the temperature in the enclosure, which thus contributes towards controlling the temperature of the part, but also of the entire machining module 110, including the tools, during the machining of the part. The control of the temperature of the part when it is machined in the machining module 110 is further improved by the control of the temperature of the lubrication liquid.

Optionally, the enclosure 114 of the machining module 110 is sealed when the front door 113 is closed. By this means, when said enclosure 114 is sealed against the air, it is possible to control the temperature more easily. Alternatively, if the enclosure 114 of the machining module 110 does not have good sealing against air, it is possible to put it under low pressure, i.e. under pressure which is lower than atmospheric pressure, by means of a system for creation of low pressure (not represented). Sealing/creation of low-pressure of this type has the advantage of preventing leakage of oil vapors from the enclosure 114.

Also, the machining module 110 has a vapor aspiration system which is present in the enclosure, and is equipped with a duct for discharge of the vapors 140.

In order to facilitate visual checking of the state of operation of each machining module 110, and more generally each machining unit 100, a visual indicator of the state of operation is optionally provided, such as an indicator lamp 142 (see FIGS. 1 to 3). Different positions of the indicator lamp 142 allow the operator to determine the state of the corresponding machining module 110. According to one example from amongst different possible color codes, the indicator lamp is green when the machining module 110 is functioning normally, orange when the machining module is functioning but intervention by the operator is necessary, and red when the machining module 110 is at a standstill, and requires the intervention of the operator in order to restart it.

Said machining module 110 also comprises a store 127 for bars to be machined situated in the enclosure 114 at the rear of the machining assembly 120 (see FIGS. 1 to 3). This store 127 for bars to be machined supplies said machining assembly 120 bar by bar. According to one possibility, the mechanism for loading the bar to be machined on the spindle 124 is autonomous, and functions independently from the spindle 124. For example, the store 127 for bars to be machined functions with the descent by gravity of the stack of bars, then the thrust of the lower bar of the stack of bars in the direction of the machining assembly 120. Thus, this store 127 of bars to be machined forms a replenishment unit for the machining assembly 120 by supplying the part-holder 124, and thus from the rear of the machining module 110 (from the right in the figures). Series of bars with different diameters and/or different materials which are already ready allow the operator to reload the store 127 quickly and easily.

Said bars optionally have a length shorter than 1 m. With quite short bars to be machined, there is reduction not only of the space required on the ground by the store 127, but also this contributes to reducing the vibrations during the machining of the bar, which ensures the stability of the machining process and therefore good machining quality. In addition, the short size of the bar makes it possible to make the bar advance without particular guiding as far as the part-holder 124, i.e. the spindle.

Reference is now made to FIGS. 6 to 9 representing a variant of the first embodiment and a second embodiment of the machining unit according to the disclosure comprising a plurality of machining modules placed side-by-side.

In the case of the variant of the first embodiment shown in FIGS. 6 and 7, the machining unit 100 comprises a plurality of machining modules 110₁, 110₂, 110₃, 110₄, 110₅, similar to the machining module 110 described in relation with FIGS. 1 to 5, placed side-by-side, and adjoined of one another via the lateral walls 112a, 112b of their respective protective compartment 112. In this case, each machining module 110₁, 110₂, 110₃, 110₄, 110₅ is independent and autonomous in terms of its functioning and equipment.

In the case of the second embodiment shown in FIGS. 8 and 9, the machining unit 100 comprises a plurality of machining modules 110₁, 110₂, 110₃, 110₄, 110₅, similar to the machining module 110 described in relation to FIGS. 1 to 5, apart from the following differences:

the protective compartments 112 of all the machining modules 110ᵢ form only a single envelope (a single cowl) with as many compartments as there are machining modules 110ᵢ (with five compartments forming five enclosures 114 for five machining modules 110₁, 110₂, 110₃, 110₄, 110₅, for the example illustrated in FIGS. 8 and 9);

the lubrication liquid recycling circuit is common to said plurality of machining modules 110₁, 110₂, 110₃, 110₄, 110₅;

there is a single electrical control box 152 and a single control system 151 which are common for said plurality of machining modules 110₁, 110₂, 110₃, 110₄, 110₅.

In the case of enclosures 114 which are not sealed, a system for creation of low pressure (not represented) can be provided which is common to said plurality of machining modules 110₁, 110₂, 110₃, 110₄, 110₅.

It is also possible to provide (situation not represented) a swarf container 128 common to said plurality of machining modules 110₁, 110₂, 110₃, 110₄, 110₅.

In the presence of a system for aspiration of the humidity contained in the enclosures 114, this aspiration system is optionally common to said plurality of machining modules 110₁, 110₂, 110₃, 110₄, 110₅, and is equipped with a single duct 140 for discharge of the humidity (see FIGS. 8 and 9).

Thus, sharing of some or all of the peripheral systems, such as the oil container 129 and the swarf container 128, the system for creation of low pressure, the electrical control box 152 and the control system 151, also contributes to reduction of the surface area on the ground and reduces the cost of the machining unit 100, thus making it possible to carry out a plurality of machining operations simultaneously.

Otherwise, each machining module 110₁, 110₂, 110₃, 110₄, 110₅ functions like the machining module 110 described in relation with FIGS. 1 to 5, and has a machining assembly 120 which functions independently from the other machining assemblies, and is accessible in the second position of the corresponding movable carriage 130.

It will be understood that this configuration according to the variant of the first embodiment or according to the second embodiment of a machining unit with a plurality of machining modules 110ᵢ arranged compactly allows the area of accessibility of each machining module to overlap that of the two adjacent machining modules. Despite this overlapping, there is no impediment for the operator, who will intervene only on the machining module of which the movable carriage 113 is extracted from the protective casing 112, and is thus in the respective area of accessibility of this machining module. There is no obstruction, because the area of accessibility is used only when the movable carriage 130 is in its second position. This situation is represented in FIGS. 7 and 9 with the machining module 110₂ situated between two machining modules, the movable carriage 130₂ of which is in its second position, with the corresponding machining assembly 120₂ situated entirely outside the enclosure 114, and therefore accessible for the operator.

Also, in a machining unit 100 comprising a plurality of machining modules 110₁, it is possible to place machining units with identical equipment, in particular identical machining assemblies 120 (same tool-holder and same part-holder), or machining modules with different equipment, in particular different machining assemblies 120 (different tool-holder(s) and/or part-holder(s)).

In this last case, for example one or a plurality of machining units form(s) a machining module with 3 axes, and one or a plurality of machining modules form(s) a machining module with at least 5 axes or also 6 axes. The tool-holder 124 comprises at least one spindle, but a second spindle, such as a counter-spindle, can also equip the machining assembly 120. The tool-holder 122 can be a single comb which can support a plurality of tools, or also two combs, three combs, or in general more than two combs.

Five machining modules 110₁, 110₂, 110₃, 110₄, 110₅ constitute the machining unit 100 according to the variant of the first embodiment illustrated in FIGS. 6 and 7, and the machining unit 100 according to the second embodiment, illustrated in FIGS. 8 and 9, but it is understood that the machining unit 100 can comprise only two, three, four or also more than five machining modules 110ᵢ.

Thus, thanks to the presence of different machining modules in the same machining unit, it is possible to produce simultaneously different parts, and in particular a plurality of parts which are designed to be assembled together, such as the components of a watch movement. By way of example, one of the machining modules forms a transfer machine which makes it possible to produce bridges and discs, whereas other machining modules form automatic lathes with the tool-holder functioning as a gripper or as a gripper and tailstock sleeve (bush), and can produce complex parts and/or parts turned with different bar diameters. According to another example, one of the machining modules 110 constitutes a milling machine for partial machining of certain components such as bridges or discs, whereas other machining modules form another type of machining module, such as an automatic lathe (turning machine) or another type of machining machine.

In addition, it is understood that, since each machining module 110 has vibratory and thermal characteristics which are known and preferably controlled, it is the entire machining unit 100 which functions with a machining process which is controlled thermally and in terms of vibration, such that the stability of the machining and the quality of the resulting parts are improved.

### REFERENCE NUMBERS USED IN THE FIGURES

100 Machining unit
110 Machining module
112 Protective compartment
112a Lateral wall
112b Lateral wall
112c Upper wall
112d Lower wall
112e Rear wall
112f Front wall
113 Front door
114 Enclosure
116 Opening
120 Machining assembly
122 Tool-holder
124 Part-holder (spindle)
125 Counter-spindle
126 Support base
127 Store of bars to be machined
128 Swarf container
129 Oil container
130 Movable carriage
132 Guide rails
140 Humidity discharge duct
142 Indicator lamp
151 Control system
152 electrical control box

What is claimed is:

1-22. (canceled)

23. A machining unit comprising at least one machining module,
said machining module comprising a protective compartment which delimits an enclosure and has a front door, wherein said front door can go from a closed position to an open position defining an opening,
said machining module further comprising a machining assembly provided with a tool-holder and a part-holder,
said machining module further comprising a movable carriage and a guide device, said movable carriage being configured to receive said machining assembly and wherein,
said movable carriage is configured to slide on said guide device between
a first position, in which said machining assembly is accommodated in said enclosure and the front door can be closed for the purpose of carrying out machining of a part by said machining assembly, and
a second position in which the carriage projects from the protective compartment via said opening, and in which said machining assembly is situated outside said enclosure, which second position permits access to the machining assembly from the exterior of the protective compartment.

24. The machining unit as claimed in claim 23, wherein, in the second position of the movable carriage, the vertical projection of the machining assembly is situated on the exterior of the vertical projection, or at least of the support polygon of the protective compartment.

25. The machining unit as claimed in claim 23, wherein the front door can be pivoted between its open position and its closed position.

26. The machining unit as claimed in claim 23, wherein the front door opens downwards.

27. The machining unit as claimed in claim 26, wherein the sliding movement of said carriage is carried out after the opening or before the closure of the front door.

28. The machining unit as claimed in claim 23, wherein said enclosure can be put under pressure which is lower than atmospheric pressure.

29. The machining unit as claimed in claim 23, wherein the machining module is equipped with a compartment for collection of the lubrication liquid and a circuit for recycling said lubrication liquid.

30. The machining unit as claimed in claim 29, wherein said circuit for recycling said lubrication liquid is thermostatted.

31. The machining unit as claimed in claim 23, wherein said enclosure is thermostatted.

32. The machining unit as claimed in claim 23, wherein said machining module also comprises a store for bars to be machined which supplies said machining assembly bar by bar.

33. The machining unit as claimed in claim 32, wherein said bars have a length of less than 1 m.

34. The machining unit as claimed in claim 23, comprising a plurality of machining modules placed side-by-side adjoined to one another.

35. The machining unit as claimed in claim 34, wherein the machining module is equipped with a compartment for collection of the lubrication liquid and a circuit for recycling said lubrication liquid wherein the lubrication liquid recycling circuit and/or the swarf container is/are common to said plurality of machining modules.

36. The machining unit as claimed in claim 34, comprising an electrical control box and a single control system for said plurality of machining modules.
